(19) United States
(12) Patent Application Publication
(10) Pub. No.: US 2005/0176912 A1
(43) Pub. Date: Aug. 11, 2005

(54) Composition for polyurethane elastomer having high hardness and excellent abrasion resistance

(76) Inventors: Junghwan Shin, Ulsan (KR); Jongmyung Lee, Daejeon (KR); Inha Park, Ulsan (KR)

Correspondence Address: Abelman Frayne & Schwab, 150 East 42nd Street, New York, NY, 10017-5612, US

(21) Appl. No.: 10/503,738

(22) PCT Filed: Feb. 4, 2003
(86) PCT No.: PCT/KR03/00244

(30) Foreign Application Priority Data
Feb. 4, 2002 (KR) 10-2002-0006309

(51) Int. Cl. C08G 18/00

(52) U.S. Cl. 528/44

(57) ABSTRACT

A composition is provided for preparing a polyurethane elastomer, which is of high hardness and excellent abrasion resistance. The composition comprises a urethane prepolymer with an unreacted isocyanate content of 5-22% by weight, made from the reaction of a mixture of an aromatic diisocyanate and a cycloaliphatic diisocyanate in weight proportions of 1:0.1 to 1:5 with a polyol having a weight average molecular weight of 200-3,000; and a curing system comprising a mixture of an aromatic amine and an alcohol in weight proportions of 1:0.3 to 1:3, said alcohol comprising a multifunctional alcohol and a polyol, wherein, when the equivalent ratio between the prepolymer and the curing system is set as 100 in terms of index, they are mixed in the index range of about 70 to 200. The prepolymer is suitably controlled in viscosity and reactivity as to provide effective workability. Also, a curing system improves the hardness and abrasion resistance properties of finally produced polyurethane elastomers and allows the reactivity with prepolymer to be controlled with higher ease than dose a curing system composed of an aromatic amine alone.

### TECHNICAL FIELD

The present invention relates to a composition for polyurethane elastomers. More specifically, the present invention relates to a composition for a polyurethane elastomer, in which an isocyanate-terminated urethane prepolymer and a curing system containing active hydrogen are so suitably selected and designed as to allow the polyurethane elastomer to show high hardness and excellent abrasion resistance, while retaining its innate high elasticity.

### PRIOR ART

In general, polyurethane, known as an elastic polymer, can be prepared from a diisocyanate and a polyol in the optional presence of a chain extender. The elasticity of polyurethane is primarily determined by kinds and formulations of the materials. However, an improvement in the hardness of polyurethane with maintenance of high elasticity gives many limitations to usable materials as well as their workability. For example, hardness is improved when there is used a relatively low molecular weight polyol (or diol), an aromatic diisocyanate, or an aromatic or at least tri-functional chain extender. In this regard, there are disclosed many prior arts. For example, U.S. Pat. No. 3,194,793 discloses a polyurethane composition cured with mixtures of primary and secondary aromatic diamines, and U.S. Pat. No. 3,736,295 discloses a method for preparing polyurethane elastomers by reacting an organic diisocyanate with an organic polyol with the use of aromatic diamines containing ether linkages as a chain extender, which contain chlorine in the ortho-position with respect to the amino groups.

However, the materials mentioned above are found to deteriorate the elasticity characteristic to polyurethanes. In addition, the aromatic diisocyanante is too reactive with low molecular weight polyols and particularly with aromatic chain extenders to allow sufficient working time and optimal conditions. Moreover, the rapid reaction produces high heat of reaction (exothermic), resulting in non-uniform products. Especially, it is well known that polyurethane resins can be applied to polishing pads for use in the fabrication of semiconductors, but the polishing pads are difficult to use for fabrication of semiconductor devices because heterogeneity may be caused in the polishing pads when the high reaction heat is not released to the exterior.

On the whole, polyurethane polishing pads have been used in an application offering a super-fine mirror surface to establish global planarization of a wafer of a semiconductor device, and the method using the polyurethane polishing pads is referred to as a chemical mechanical polishing (CMP) process, in which a slurry is injected into a space between a polishing pad and a wafer to chemically corrode the surface of the wafer, followed by mechanically polishing the corroded surface.

In order to better understand the background of the invention, a typical chemical mechanical polishing technique is explained in conjunction with drawings.

With reference to FIG. 1, there is shown a general polishing apparatus 1, while a principle of a CMP process by the polishing apparatus 1 is illustrated in FIG. 2. This polishing process involves a chemical corrosion process and a mechanical polishing process, which are accomplished on a polishing pad i0 of the polishing apparatus 1.

The chemical corrosion is accomplished by slurry 42, and the slurry 42 induces the chemical reaction of a surface of a wafer 30, allowing the subsequent mechanical planarizaton process to be carried out easily. During the polishing process, the polishing pad 10 rotates in a fixed state at a platen 20, and the wafer 30 rotates with simultaneous oscillation in a fixed state at a retainer ring 32. At this time, polishing particles of the slurry supplied on the polishing pad by a slurry supply device 40 are introduced into a space between the polishing pad 10 and the wafer 30, and then the introduced polishing particles perform a mechanical polishing process by their abrasion with the wafer 30 owing to the different rotation velocity between the wafer 30 and the polishing pad 10. The slurry 42, a liquid of colloidal form containing polishing particles of nanometer size, is sprayed on the polishing pad 10 during the planarizaton process, and upon rotation of the pad, the supplied slurry is ejected to the outside of the circumference of the polishing pad 10 by centrifugal force.

Therefore, to increase polishing rate and establish global planarizaton, it is required that the polishing pad have a good wetting capacity for the slurry and show uniform hardness or abrasion resistance thereover. However, heterogeneity caused by the high heat of reaction can affect the hardness or abrasion resistance property of the polishing pad, and in the worst case, induce the scorching phenomena. Therefore, the control of reaction heat is essential for application of polyurethane elastomers to polishing pads.

To overcome these problems, there were developed prepolymer methods in which a diisocyanate is reacted first, in part, with a polyol to produce oligomers of hundreds to thousands molecular weight and the oligomers are cured by mixing with a low molecular weight polyol or an aromatic chain extender, whereby not only can the reaction rate be significantly reduced, but also the reaction heat can be optimally controlled.

Korean Pat. No. 240437 discloses a method for preparing a polyurethane elastomer in which a polyether polyol having a number average molecular weight of 650 or less and a molecular weight distribution index of 1.10-2.50 is reacted with a polyether polyol having a number average molecular weight of 2,000 or more and a molecular weight distribution index of 1.10-2.40, in the presence of an amine chain extender as a curing agent, teaching that the use of two kinds of polyols having relatively wide molecular weight distributions brings about an improvement in the abrasion resistance as well as the phase separation which results in forming hard segments and soft segments.

U.S. Pat. No. 4,090,547 describes a urethane resin prepared by reacting a prepolymer, made from a polyol such as polytetramethylene ether glycol and a toluene diisocyanate with an isocyanate content of 4%, with methaphenylenediamine as an extender.

U.S. Pat. No. 4,604,445 discloses a process for manufacturing polyurethanes in which urethane prepolymers are made from a polyisocyanate and blends of urethane intermediates, each having hydroxyl and/or amine group and ranging from 100 to 10,000 in molecular weight, extended and cured.

In addition, U.S. Pat. No. 6,258,310 describes a process for preparing polyurethanes having excellent heat resistance and a high softening point, in which a thermoplastic polyurethane is made by reacting a bifunctional isocyanate with a polyester or a polyether diol and a monomeric and low molecular weight diol as a chain extender, and then reacting the preformed thermoplastic polyurethane with an isocyanate-terminated prepolymer.

However, previously known prepolymer methods require that unreacted isocyanates exist at a high content in a prepolymer to manufacture polyurethane having high hardness, but this can cause limitations in controlling the reactivity of the prepolymer. Further, because the urethane prepolymer made from a diisocyanate and a polyol with the aim of reducing the reactivity, in molecular weight, to hundreds to thousands and even to tens of thousands in addition to having strong hydrogen bonds between carbonyl groups (C═O) and amide groups (N—H), its use as an intermediate material is practically difficult owing to its high viscosity, and also its mixing with a curing agent may not be achieved efficiently, causing heterogeneity of the final product, polyurethane.

Therefore, there is an urgent need for a polyurethane resin that is of high hardness and excellent abrasion resistance and which also maintains high innate elasticity.

### DISCLOSURE OF THE INVENTION

To overcome the problems of the prior arts described above, the inventors of the present invention have executed many studies and developed a composition for manufacturing a polyurethane elastomer having high hardness and excellent abrasion resistance, and retaining its innate high elasticity, through suitable selection of materials and control of structures of diisocyanates and a curing system.

Accordingly, it is an object of the present invention to provide a composition for preparing a polyurethane elastomer having high hardness and excellent abrasion resistance, while retaining its innate high elasticity, through suitable selection of materials and control of structures in preparing a prepolymer and a curing system.

It is another object of the present invention to provide a composition for preparing a polyurethane elastomer having excellent abrasion resistance, characterized by being prepared using an aromatic diisocyanate capable of improving hardness of the polyurethane elastomer, and a sufficient isocyanate groups-containing prepolymer having suitably controlled reactivity and viscosity, thereby providing effective workability.

It is still another object of the present invention to provide a method for preparing a polyurethane elastomer having excellent abrasion resistance, using the composition.

To achieve the objects described above, in accordance with an aspect of the present invention, there is provided a composition for preparing a polyurethane elastomer having high hardness and excellent abrasion resistance, comprising: a urethane prepolymer with an unreacted isocyanate content of 5-22% by weight, made from the reaction of a mixture of an aromatic diisocyanate and an cycloaliphatic diisocyanate in weight proportions of 1:0.1 to 1:5 with a polyol having a weight average molecular weight of 200-3,000; and a curing system comprising a mixture of an aromatic amine and an alcohol in weight proportions of 1:0.3 to 1:3, said alcohol comprising a multifuctional alcohol and a polyol, wherein, when the equivalent ratio between the prepolymer and the curing system is set as 100 in terms of index, they are mixed in the index range of about 70 to 200.

In accordance with another aspect of the present invention, there is provided a method for preparing a polyurethane elastomer having high hardness and excellent abrasion resistance, comprising the steps of: (a) mixing an aromatic diisocyanate and an cycloaliphatic diisocyanate at a ratio of 1:0.1 to 1:5 by weight; (b) reacting the diisocyanate mixture with a polyol with a weight average molecular weight of 200-3,000 to give a urethane prepolymer with an unreacted isocyanate content of 5-22% by weight; (c) preparing a curing system by mixing an aromatic amine and an alcohol at a ratio of 1:0.3 to 1:3 by weight, said alcohol comprising a multifunctional alcohol and a polyol; and (d) curing the prepolymer by mixing the urethane prepolymer at a ratio of 70 to 200 index with the curing system, with the proviso that the equivalent ratio between the prepolymer and the curing system is set as 100 in terms of index.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view showing an embodiment of a typical polishing apparatus;

FIG. 2 is a schematic view showing a concept of a chemical mechanical polishing (CMP) process;

FIG. 3 is a graph in which workability and hardness of polyurethane elastomers are plotted versus MOCA (3,3′-dichloro-4,4′-diamino diphenylmethane) contents in a curing system;

FIG. 4 is a graph in which workability and MOCA content are plotted versus mixing indexes of a urethane prepolymer and a curing system; and

FIG. 5 is a graph in which MOCA content, hard segment content and hardness are plotted versus mixing indexes of a urethane prepolymer and a curing system.

### BEST MODES FOR CARRYING OUT THE INVENTION

According to the present invention, a polyurethane elastomer having high hardness and excellent abrasion resistance comprises two systems: an isocyanate-terminated urethane prepolymer prepared by reacting an excess of aromatic and cycloaliphatic diisocyanates with a highly elastic polyol; and a curing system consisting of a combination of an aromatic amine and an alcohol selected from highly elastic polyols and low molecular weight dihydric or polyhydric (tri or more) alcohols.

According to the present invention, an aromatic and a cycloaliphatic diisocyanate are used for preparation of a urethane prepolymer. Examples of the aromatic diisocyanate useful in the present invention may include 4,4′-diphenylmethane diisocyanate (MDI), 2,4- or 2,6-toluene diisocyanate (TDI), carbodiimide-modified MDI, and polymeric MDI. Cycloaliphatic diisocyanate useful in the present invention may be exemplified by 4,4′-dicyclohexylmethane diisocyanate (H₁₂MDI), isophorone diisocyanate (IPDI), and 1,4-cyclohexylmethane diisocyanate (CHDI). According to the present invention, the aromatic and the cycloaliphatic diisocyanate can be used individually or as mixtures, and are not limited to the compounds mentioned above.

As described above, if an aromatic diisocyanate is used alone, it is expected that hardness and abrasion resistance properties will be significantly improved, but sufficiently long working times cannot be guaranteed because of its high reactivity. In addition, if polyurethane resins are applied for preparing polishing pads of semiconductors, high reaction heat may cause the heterogeneity of the polishing pads. According to the present invention, both desired hardness and abrasion resistance properties and suitable reactivity can be obtained by mixing an aromatic and an cycloaliphatic diisocyanate at a specific ratio and then reacting the mixture with a polyol.

Hereby, an aromatic and a cycloaliphatic diisocyanate are mixed at a ratio of approximately 1:0.1 to 1:5 by weight, and preferably, at a ratio of approximately 1:0.5 to 1:3. For example, if a mixing ratio of the two diisocyanates is too low, heat of reaction is excessively generated due to a relatively high content of the aromatic diisocyanate, causing the problems described above. On the other hand, if a mixing ratio of the two diisocyanates is too high, it is difficult to obtain an effect of improving hardness, due to a relatively high content of the cycloaliphatic diisocyanate.

According to the present invention, examples of the polyol useful in the manufacture of a urethane prepolymer include polypropylene ether glycol (PPG), and polytetramethylene ether glycol (PTMEG). The polyols have a weight average molecular weight of about 200-3,000, and preferably, about 1,000-1,500. Effective as they are in improving hardness, polyols under the 200-3,000 weight average molecular weight may be effective in enhancing hardness, but cause reduction of elasticity. On the other hand, polyols over the weight average molecular weight may enhance the elasticity, but are not effective for improving hardness.

Reaction conditions for manufacture of a prepolymer for preparing polyurethane have been well known in the art to which the present invention belongs. According to the present invention, it is preferable that the reaction is performed under a nitrogen atmosphere for about 1-8 hours at about 40-90° C., and preferably, for about 2-3 hours at about 60-80° C.

When preparing a urethane prepolymer in accordance with the present invention, a reaction ratio of a diisocyanate and a polyol determines the content of unreacted isocyanates in the diisocyanate, which exert a great influence on the hardness and abrasion resistance of the polyurethane elastomer as well as the reactivity of the diisocyanate. Higher contents of the unreacted isocyanates give rise to a greater increase in hardness and abrasion resistance, but also in reactivity, thereby negatively influencing the workability of the prepolymer. Accordingly, it is important that the prepolymer contains a suitable content of unreacted isocyanates. The reaction ratio and the structure of the prepolymer should be designed in such a way that the prepolymer contain unreacted isocyanates at an amount of about 5-22% by weight, and preferably, about 8-17% by weight. For example, where the content of unreacted isocyanates exceeds 22%, although the urethane may be improved in hardness and abrasion resistance thanks to its increased hard segment content, the reactivity is too high to obtain sufficiently long working times. In contrast, in the case that the content of the unreacted isocyanates is under 5%, the resulting prepolymers become highly viscous due to their having high molecular weight and many intermolecular hydrogen bonds, deteriorating the workability, and also are difficult to mix with a curing agent, thus causing heterogeneous final products. Accordingly, because it is important that a content of the unreacted isocyanates is maintained at a suitable level, the content should be determined considering their reactivity with a curing agent and required physical properties of products.

The prepolymer manufactured as described above is cured through mixing with a curing system, and it is typical that conditions of the curing reaction are determined by time and temperature. According to the present invention, preferably, the reaction is performed at about 80-150° C. for about 12-60 hours, and more preferably, at about 90-100° C. for about 30-50 hours. For example, a low temperature or a short curing time results in insufficient hardness. On the other hand, a high temperature or a long curing time causes change in color and shape of products due to oxidation.

A curing system used in this reaction is prepared by mixing an aromatic amine at a suitable weight ratio with a mixture of multifunctional alcohols, including difunctional and trifunctional alcohols, and a polyol in predetermined proportions. It should be noted that the term “multifunctional alcohols”, as used herein, means di- and trifunctional alcohols and the term “polyols” means alcohols having four or more functional hydroxyl groups.

Representative examples of the aromatic amines useful in the present invention may include 3,3′-dichloro-4,4′-diaminodiphenylmethane (MOCA), 4,4′-diaminodiphenylmethane, 1,4-diaminobenzene, 4,4′-diamino biphenyl, and 3,3′-dichloro-4,4-diamino biphenyl.

Examples of the difunctional alcohol useful in the present invention include 1,4-butanediol, 1,3-butanediol, 1,6-hexanediol, diethylene glycol (DEG), ethylene glycol (EG), and tripropylene glycol (TPG), while the trifunctional alcohol useful in the present invention may be exemplified by glycerin, trimethylene propane (TMP), and sorbitol.

In addition, polyols are used with the difunctional and the trifunctional alcohols as alcohols, and preferably, their weight average molecular weight is about 200-3,000. Useful are polypropylene ether glycol (PPG) and polytetramethylene ether glycol (PTMEG).

According to the present invention, it is preferable that the multifunctional alcohol is mixed at a weight ratio of 1:0.5 to 0.5:1 with the polyol.

The components of the curing system and the weight ratio of the mixture significantly affect the workability which is dependent on the reactivity of the curing system with the urethane prepolymer, as well as the hardness and abrasion resistance properties of the polyurethane elastomer. Especially, an aromatic amine is far superior to the other components of the curing system in terms of the improvement of hardness and abrasion resistance properties, but it is difficult to control the reactivity of the aromatic amine when it is used alone. Therefore, according to the present invention, the aromatic amine is used in combination with a mixture of multifunctional alcohols and polyols, which are relatively poor in reactivity, so that not only can the reactivity of aromatic amines be controlled, but also the polyurethane elastomers are improved in hardness and abrasion resistance.

The weight ratio of aromatic amine to the alcohol mixture (multifunctional alcohol and polyol) is preferably on the order of 1:0.3 to 1:3. Moreover, a ratio of about 1:1 to 1:2 can provide the most effective workability, hardness, and abrasion resistance properties. In the case that an aromatic amine is mixed with alcohols in a weight ratio exceeding the upper limit of the range, an excessive reactivity is obtained, leading to poor workability. On the other hand, where the weight ratio of the aromatic amine to the alcohol mixture is below the lower limit, it is difficult to obtain sufficient hardness and abrasion resistance properties.

When the equivalent ratio between the isocyanate-terminated prepolymer and the curing system is set as 100 in terms of index, they are mixed in the index range of about 70 to 200 in accordance with the present invention. Moreover, the index range of about 80 to 120 can provide the most desirable reactivity and hardness and abrasion resistance properties. For example, in the case that an index exceeds the desirable range of about 80 to 120, the equivalent unbalance between the prepolymer and the curing system results in the production of non-homogeneous polyurethane elastomers. However, even in the case that an index exceeds the desirable range, reactivity can be widely controlled by falling the preparation temperatures of the prepolymer and the curing system within the range of about 50-100° C. and by controlling the curing temperature within the range of about 80-150° C., in accordance with the present invention. This is possible because the secondary reactions of polyurethanes, such as allophanate and biuret reactions, are accomplished at a high temperature, and the secondary reactions can be controlled by changing temperatures. Accordingly, when using this technique, the index range can be extended to about 70 to 200.

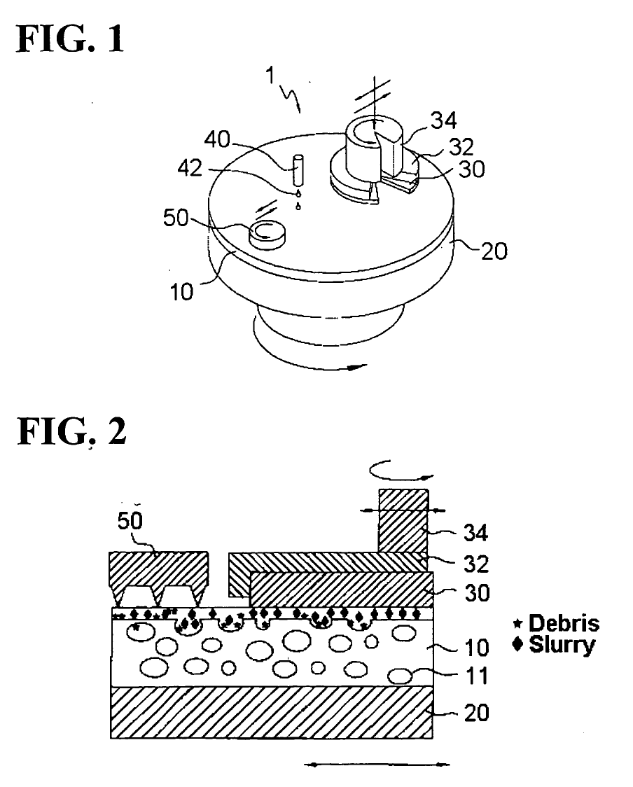

Polyurethane elastomers prepared according to the present invention, especially, can be applied to pads used in a chemical mechanical polishing process (CMP process) for manufacturing a semiconductor. Generally, the polishing pads must be highly resistant to acid or alkali in addition to being uniform in hardness and abrasion resistance therethrough, regardless of their size. Polyurethane elastomers of the present invention can provide the physical properties, which suit these requirements. As for polyurethanes manufactured according to the prior art, their physical properties were less uniform over their entire area owing to the high reaction heat when their size is larger. For this reason, the conventional polyurethanes cannot guarantee regular polishing rates in a semiconductor polishing process illustrated in FIG. 1. Additionally, the heterogeneity of polishing pads causes a slurry used as a polishing agent to show a heterogeneous wetting property, resulting in scratches being produced on a wafer.

The present invention will be explained in more detail with reference to the following examples in conjunction with the accompanying drawings. However, the following examples are provided only to illustrate the present invention, and the present invention is not limited to them.

In the present invention, reactivity and hardness were evaluated according to the following methods.

Reactivity

Reactivity was determined as the period of time (pot life) from a mixing point to a curing point of an isocyanate-terminated prepolymer and a curing agent, and the curing point is a point of time when the surface of the prepolymer no longer yielded to a glass stick.

Hardness

A polyurethane elastomer after the pot life was sufficiently cured at 80-100° C. for 48 hours, cooled to a room temperature and was then analyzed for hardness with Shore D.

### EXAMPLE 1

2,200 weight part of polytetramethylene ether glycol (PTMEG; PTMEG 2000, Korea PTG Co., Korea) was added to 1700 weight part of a mixture of the aromatic diisocyanate, 4,4′-diphenylmethane diisocyanate (MDI; Cosmonate PH, Kumho Mitsui Chemicals, Inc., Korea) and the cycloaliphatic diisocyanate, 4,4′-dicyclohexylmethane diisocyanate (H₁₂MDI; Desmodur W, Bayer Co.) in weight proportions of 1:0.5, followed by reacting them at 80° C. for 2 hours. The resulting isocyanate-terminated urethane prepolymer was found to contain unreacted isocyanate groups in an amount of about 12.5% by weight, as analyzed by n-dibutylamine back-titration. The isocyanate-terminated prepolymer was charged to a tank and then maintained at 60° C. Separately, 3,3′-dichloro-4,4′-diaminophenylmethane (MOCA; Cuamine-M, Ihara Chemicals Co.) was mixed at various amounts, as shown in Table 1, below, with an alcohol mixture of polytetramethylene ether glycol and glycerol (Glycerin, Oriental Chemical Industries, Korea) in proportions of 1:1 by weight, to form curing systems with different MOCA contents. The curing systems were maintained at 80° C., and a mold was preheated to 90° C.

The urethane prepolymer and the curing system, maintained at constant temperatures, were injected from the tank through an inlet into the preheated mold after being mixed together at an index of 120. They were cured primarily at 90° C. for 30 minutes, and secondarily at 100° C. for 48 hours.

After completion of the curing, polyurethane elastomers thus obtained were tested for reactivity and hardness, and the results are given in Table 1, below and FIG. 3.

TABLE 1

| | MOCA content (%) | | | | | | |
|---|---|---|---|---|---|---|---|
| | 5 | 8.9 | 12.1 | 14.9 | 17.2 | 20.4 | 21.6 |
| Pot life | ≧24 hr | 30 min | 24 min | 13 min | 14 min | 12.5 min | 12 min |
| Hardness | — | 28-30 | 35-37 | 48-50 | 55 | 60-62 | 65-68 |
| (Shore D) | | | | | | | |

As apparent in Table 1 and FIG. 3, MOCA functioned as a catalyst in the curing reaction and did not influence the reaction velocity any further, when reaching a certain level. In addition, hardness values (Shore D) varied with MOCA contents in a proportional relationship. It was also found that both an effective workability and a sufficient hardness could be obtained even at a MOCA content of 20% by weight or higher in a urethane composition, whereas low MOCA contents might be effective in terms of workability, but could not guarantee sufficient hardness. Further, as will be described later, the same effects as in low MOCA contents were obtained when no aromatic amines were used.

### COMPARATIVE EXAMPLE 1

Using the same method as in Example 1, an isocyanate-terminated urethane prepolymer was prepared, and then maintained at a temperature of 60° C. Polytetramethylene ether glycol was mixed at various ratios, as shown in Table 2, below, with glycerol, and the curing agents thus obtained were maintained at 80° C. A mold was preheated to 80° C. The urethane prepolymer and the curing system were injected from the tank through an inlet into the preheated mold after being mixed together at an index of 105 and 120. They were cured primarily at 80° C. for 6 hours, and secondarily at 100° C. for 48 hours.

After completion of the curing, polyurethane elastomers thus obtained were tested for hardness according to changes in a mixing ratio of polytetramethylene ether glycol and glycerol, and the results are shown in Table 2, below.

TABLE 2

| | Test 1 | Test 2 | Test 3 | Test 4 | Test 5 | Test 6 | Index |
|---|---|---|---|---|---|---|---|
| polytetramethylene | 1/1 | 1/3 | 1/5 | 1/7 | 1/9 | 0/1 | |
| ether glycol/glycerol | | | | | | | |
| Hardness | 30-35 | 30-35 | 35-40 | 40-45 | 40-45 | 45-48 | 105 |
| (Shore D) | 43-48 | 45-46 | 45-47 | 45-46 | 45-46 | 47-48 | 120 |

Where an aromatic amine was not used in the curing system, pot life was over 30 minutes in all tests, which demonstrates that reactivity can be easily controlled in a composition without an aromatic amine. However, in the absence of aromatic amine, as shown in Table 2, Shore hardness obtained was lower than that of Example 1.

### EXAMPLE 2

Using the same method as Example 1, an isocyanate-terminated prepolymer was manufactured, and then maintained at 60° C. And then, an aromatic amine compound, 3,3′-dichloro-4,4′-diaminophenylmethane (MOCA; Cuamine-M, Ihara Chemicals Co.) was mixed at an amount of 50% by weight with an alcohol mixture of polytetramethylene ether glycol and glycerol (Glycerin, Dong Yang Chemical Co., Korea) in a ratio of 1:1 by weight, corresponding to the change of MOCA content in a composition for preparing a polyurethane described in Table 1, and then maintained at 80° C., and a metal mold was preheated to 90° C.

The urethane prepolymer and the curing system, maintained at constant temperatures, were injected from the tank through an inlet into the preheated mold after being mixed together at an index of from 80 to 120. They were cured primarily at 90° C. for 30 minutes, and secondarily at 100° C. for 48 hours.

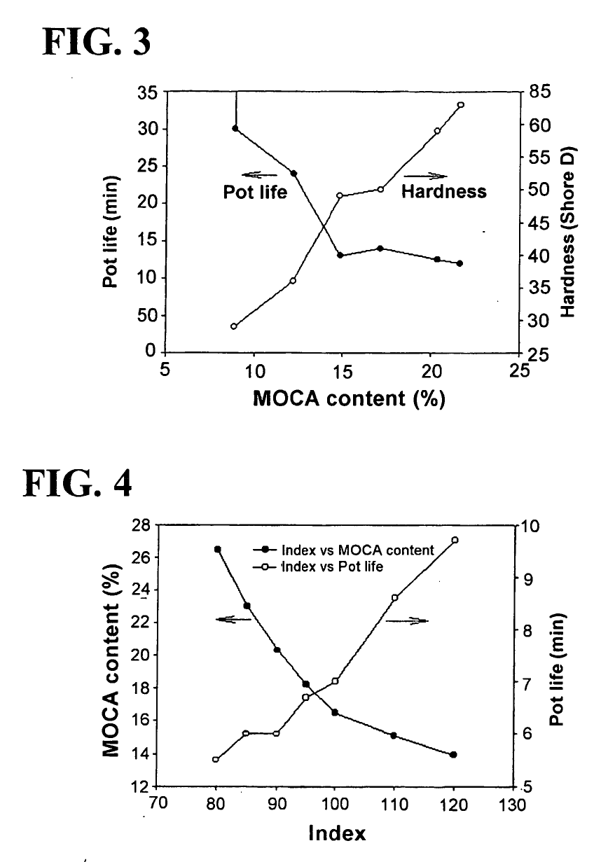

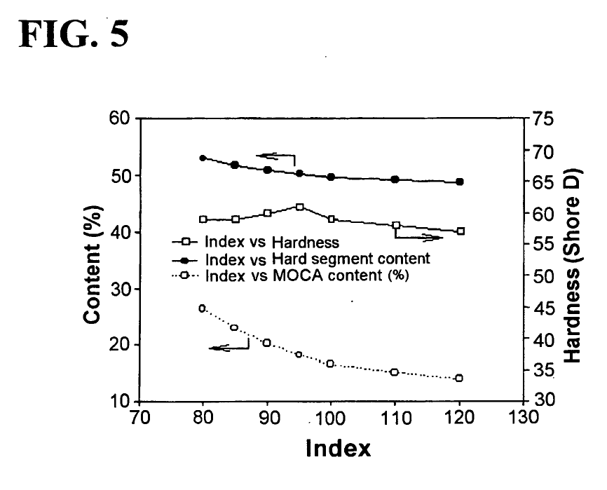

After curing, reactivities and hardnesses of obtained polyurethane elastomers were tested and are shown in Table 3 and FIGS. 4 and 5 according to changes in an index. The MOCA content of FIGS. 4 and 5 is represented as weight % based on the total weight of the polyurethane composition.

TABLE 3

| | Index | | | | | | | | | | | |
|---|---|---|---|---|---|---|---|---|---|---|---|---|
| | 80 | | 85 | | 90 | 95 | | 100 | 110 | | 120 | |
| Pot life | 5 | min | 5 | min | 6 min | 6 | min | 7 min | 8 | min | 9 | min |
| | 30 | sec | 30 | sec | | 30 | sec | | 50 | sec | 40 | sec |

| | | | | | | | |
|---|---|---|---|---|---|---|---|
| Hardness | 57-58 | 59 | 59 | 61 | 58 | 57 | 55 |
| (Shore D) | | | | | | | |

As shown in Table 3 and FIGS. 4 and 5, reactivity could be controlled in a wider range by changing the index, within the range of from 80 to 120, rather than by changing the mixing ratio of alcohols and MOCA in the curing system. This is because a change in the index, while maintaining the curing system at a constant content, causes a change in the MOCA content of the total composition. However, at an extremely low or high index (below 70 or over 200 index), heterogeneity was observed in a product owing to the unbalance between equivalents of the prepolymer and the curing system.

### EXAMPLE 3

To investigate the stability of polyurethane elastomers prepared in Example 2 to acid or alkali, their hardness was analyzed after storage in strong acid or strong alkali solutions at 60° C. for 1 week, and results are shown in Table 4, below.

TABLE 4

| | | Index | | | | | | |
|---|---|---|---|---|---|---|---|---|
| | | 80 | 85 | 90 | 95 | 100 | 110 | 120 |
| Hardness | The early stage | 57-58 | 59 | 59 | 61 | 58 | 57 | 55 |
| (Shore D) | pH 2.5-3 | 55 | 59 | 57-59 | 60 | 58 | 56 | 55 |
| | pH 11-11.5 | 57 | 58 | 55-58 | 61 | 58 | 57 | 52-54 |

As shown in Table 4, the hardnesses of the polyurethane elastomers were rarely changed even under the strong acid or strong alkali conditions.

### EXAMPLE 4

An examination was made of the hardness of polyurethane elastomers prepared with the use of the same curing system as in Example 2, according to the contents of aromatic and cycloaliphatic diisocyanates, and the results are given in Table 5, below.

TABLE 5

| | Test 1 | Test 2 | Test 3 | Test 4 | Test 5 | Test 6 |
|---|---|---|---|---|---|---|
| Aromatic/cycloaliphatic | 1/0 | 1/0.1 | 1/0.5 | 1/1 | 1/5 | 1/8 |
| diisocyanate | | | | | | |
| Pot life | ≦1 min | 5 min | 13 min | 25 min | 60 min | 3-4 hr |
| Hardness (Shore D) | 55 | 52 | 48 | 45 | 42 | 32 |

As shown in Table 5, the Shore hardness of the product increased as the content of aromatic diisocyanate increased, but in this case, sufficient working times could not be obtained owing to the high reactivity of aromatic diisocyanate. In contrast, higher contents of the cycloaliphatic diisocyanate allow for longer working times, but cannot sufficiently improve hardness levels of products.

### INDUSTRIAL APPLICABILITY

As described above, a composition comprising an isocyanate-terminated urethane prepolymer and a curing system is provided for preparing a polyurethane elastomer, which is of high hardness and excellent abrasion resistance, while retaining its innate high elasticity. Especially, the prepolymer, in which an aromatic diisocyanate is used in order to improve hardness of finally produced polyurethane elastomers, is designed to have a sufficient content of isocyanate groups, and is so suitably controlled in viscosity and reactivity as to provide effective workability. In addition, a curing system composed of a suitable combination of an aromatic amine and alcohols (especially, polyol) improves the hardness and abrasion resistance properties of finally produced polyurethane elastomers and allows the reactivity with prepolymer to be controlled with higher ease than does a curing system composed of an aromatic amine alone. Furthermore, the polyurethane elastomer prepared according to the present invention is extremely useful for a pad for a chemical mechanical polishing (CMP) process for preparing semiconductor devices.

1. A composition for preparing a polyurethane elastomer having high hardness and excellent abrasion resistance, comprising:
a urethane prepolymer with an unreacted isocyanate content of 5-22% by weight, made from the reaction of a mixture of an aromatic diisocyanate and a cycloaliphatic diisocyanate in weight proportions of 1:0.1 to 1:5 with a polyol having a weight average molecular weight of 200-3,000; and
a curing system comprising a mixture of an aromatic amine and an alcohol in weight proportions of 1:0.3 to 1:3, said alcohol comprising a multifunctional alcohol and a polyol,
wherein, when the equifunctional ratio between the prepolymer and the curing system is set as 100 in terms of index, they are mixed in the index range of about 70 to 200.

2. The composition as set forth in claim 1, wherein the aromatic diisocyanate is selected from the group consisting of 4,4′-diphenylmethane diisocyanate (MDI), 2,4- or 2,6-toluene diisocyanate (TDI), carbodiimide-modified MDI, polymeric MDI, and mixtures thereof.

3. The composition as set forth in claim 1, wherein the cycloaliphatic diisocyanate is selected from the group consisting of 4,4′-dicyclohexylmethane diisocyanate (H₁₂MDI), isophorone diisocyanate (IPDI), 1,4-cyclohexylmethane diisocyanate (CHDI), and mixtures thereof.

4. The composition as set forth in claim 1, wherein the polyol used in both the prepolymer and the curing system is polypropylene ether glycol (PPG), or polytetramethylene ether glycol (PTMEG).

5. The composition as set forth in claim 1, wherein the alcohol of the curing system is a mixture of the multifunctional alcohol and the polyol in weight proportions of about 1:0.5 to 0.5:1.

6. The composition as set forth in claim 1, wherein the aromatic amine is selected from the group consisting of 3,3′-dichloro-4,4′-diaminophenylmethane (MOCA), 4,4′-diaminodiphenylmethane, 1,4-diaminobenzene, 4,4′-diaminobiphenyl, and 3,3′-dichloro-4,4-diaminobiphenyl.

7. The composition as set forth in claim 1, wherein the multifunctional alcohol is di- or tri-functional alcohol, said difunctional alcohol being selected from the group consisting of 1,4-butanediol, 1,3-butanediol, 1,6-hexanediol, diethylene glycol (DEG), ethylene glycol (EG), and tripropylene glycol (TPG), said trifunctional alcohol being selected from the group consisting of glycerin, trimethylene propane (TMP), and sorbitol.

8. A method for preparing a polyurethane elastomer having high hardness and excellent abrasion resistance, comprising the steps of:
(a) mixing an aromatic diisocyanate and an cycloaliphatic diisocyanate at a ratio of 1:0.1 to 1:5 by weight;
(b) reacting the diisocyanate mixture with a polyol with a weight average molecular weight of 200-3,000 to give a urethane prepolymer with an unreacted isocyanate content of 5-22% by weight;
(c) preparing a curing system by mixing an aromatic amine and an alcohol at a ratio of 1:0.3 to 1:3 by weight, said alcohol comprising a multifunctional alcohol and a polyol; and
(d) curing the prepolymer by mixing the urethane prepolymer at a ratio of 70 to 200 index with the curing system, with the proviso that the equivalent ratio between the prepolymer and the curing system is set as 100 in terms of index

9. The method as set forth in claim 8, wherein the step (a) is performed at 40-90° C. for 1-8 hours.

10. The method as set forth in claim 8, wherein the step (d) is performed at 80-150° C. for 12-60 hours.
